(19) United States
(12) Patent Application Publication
(10) Pub. No.: US 2025/0287985 A1
(43) Pub. Date: Sep. 18, 2025

(54) PELLET FORMING EXTRUSION APPARATUS

(71) Applicant: B&T Technologies, LLC, Coral Springs, FL (US)

(72) Inventor: William H. Moss, Coral Springs, FL (US)

(21) Appl. No.: 19/078,754

(22) Filed: Mar. 13, 2025

Related U.S. Application Data
(60) Provisional application No. 63/564,746, filed on Mar. 13, 2024.
(60) Provisional application No. 63/565,799, filed on Mar. 15, 2024.

(51) Int. Cl. A23N 17/00; A23P 30/20

(52) U.S. Cl. CPC A23N 17/005; A23P 30/20

(57) ABSTRACT

A pelletizer with a removable pelletizer die is disclosed, including a plurality of bolts and a plurality of precision pins each provided in a plurality of flanges to fasten a pelletizer die. The plurality of bolts and the plurality of precision pins enable an operator to disassemble and clean a pelletizer die and replace the pelletizer die in a suitable position. A drive side shaft seal and an end each include a removable internal bushing, a larger surface and packing with an outside flange surface using the plurality of bolts to compress the packing.

### CROSS-REFERENCE TO RELATED APPLICATIONS

The present application claims priority to U.S. Provisional Patent Application No. 63/564,746 filed Mar. 13, 2024, titled “REMOVABLE PELLETIZER DIE”; U.S. Provisional Application No. 63/565,799 filed Mar. 15, 2024, titled “PELLETIZER ROTOR EXTRUDING PUSH FACE WEDGE”, each of which is hereby incorporated by reference in its entirety.

### TECHNICAL FIELD

The present invention relates generally to a material drying apparatuses and more specifically to improvement to a pellet forming extrusion apparatus.

### BACKGROUND

This invention finds specific application in the field of drying and/or dehydrating food residuals, food byproducts and food waste for upcycling into merchantable products (for example) animal feed ingredients that can substitute for cereal grains. More specifically, the ability to take wet mixtures of food residuals, food byproducts and food waste and extrude these mixtures into uniform shapes that can be dried more uniformly in fluidized bed dryers.

One particular treating process that has been found uniquely effective in processing of grain such as soybeans as well as corn and other cereal grain is subjecting them to elevated temperatures of predetermined magnitude and particular length of time whereby the nutrients of the grains will be processed to a state where they are more efficient in the providing of the nutrients to the livestock during the course of the digestive process. Additionally, in connection with soybeans, such heat treatment also has the advantage of converting the soybeans to a state where they are more readily digested by livestock and thus substantially enhances their utilization.

Pelletizing or shaping non-uniform, wet heterogenous mixtures into uniform shapes is a requirement for fluid-bed drying. The prior art, specifically U.S. Pat. No. 6,099,288 described a pelletizer die having a simplistic shaft seal on an end which provided limited bearing surface and caused the pelletizer to jam if dry material was accidentally reintroduced. Further the '288 Patent included bolted flanges that were difficult to relocate properly so that the screw had proper clearances when it was disassembled and cleaned.

### SUMMARY OF THE INVENTION

This summary is provided to introduce a variety of concepts in a simplified form that is further disclosed in the detailed description of the embodiments. This summary is not intended for determining the scope of the claimed subject matter.

A pelletizer with a removable pelletizer die is disclosed, including a plurality of bolts and a plurality of precision pins each provided in a plurality of flanges to fasten a pelletizer die. The plurality of bolts and the plurality of precision pins enable an operator to disassemble and clean a pelletizer die and replace the pelletizer die in a suitable position. A drive side shaft seal and an end each include a removable internal bushing, a larger surface and packing with an outside flange surface using the plurality of bolts to compress the packing.

The embodiments provide an improvement compared to the prior art by including an easily removable pelletizer die to clean the perforations in the pelletizer die and clean out the spaces in-between the auger plates of the series of configured plates arranged along a common axis to form a combined auger-shaped extruding rotor. This is accomplished by drilling and inserting precision pins in each flange set to allow the operator to disassemble the pelletizer die and reinstall it in the exact same position it was installed from the factory. The embodiments also include a machined drive side shaft seal and end seal with a removable internal bushing, larger surface, and packing with an outside flange to compress the packing, thus reducing jams caused by the accidental reintroduction of dried materials and/or sugars.

In some aspects, the plurality of precision pins each operate as a locator pin to enable the operator to remove the removable pelletizer die and replace the removable pelletizer die in the same position from which it was removed.

In some aspects, the pelletizer with removable pelletizer die includes a plurality of perforations for forming a pellet from a dried material.

In some aspects, the pelletizer with removable pelletizer die includes a plurality of auger plates arranged to form an extruding rotor.

In some aspects, pelletizer with removable pelletizer die is further comprised of: at least one removable internal bushing.

In some aspects, the pelletizer with removable pelletizer die includes an extruding rotor integrated with a pusher face plate wedge.

In some aspects, the extruding rotor of the auger is constructed with multiple auger plates that are formed with a single-component push face wedge.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a prior art reference depicting a pelletizer die;

FIG. 2A illustrates a prior art reference depicting a two-part pusher face plate wedge welded to an extruder rotor plate;

FIG. 2B illustrates a prior art reference depicting a two-part pusher face plate wedge welded to an extruder rotor plate;

FIG. 3 illustrates a schematic of the pellet forming extrusion apparatus, according to some embodiments;

FIG. 4 illustrates a schematic of a single-part pusher face plate wedge with the extruder rotor plate replacing the 2-part pusher face wedge disclosed in the prior art, according to some embodiments.

FIG. 5 illustrates a perspective view of the pellet forming extrusion apparatus, according to some embodiments;

FIG. 6A illustrates a perspective view of the pellet forming extrusion apparatus, according to some embodiments;

FIG. 6B illustrates a perspective view of the pellet forming extrusion apparatus, according to some embodiments; and

FIG. 6C illustrates a perspective view of the pellet forming extrusion apparatus, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein are an improvement to a removable pelletizer die which allows for the efficient cleaning of the perforations of the pelletizer die to remove objects which are known to build up and thus clog the pelletizer die. The removable pelletizer die is installed using a plurality of fasteners allowing an operator to easily disassemble and remove the pelletizer die. The pelletizer die can then be cleaned and replaced in the same position it was removed from.

The removable pelletizer die includes a pelletizer rotor extruding push face wedge including a CNC or laser cut pattern to merge two parts into one in CNC or laser cutting operation. During manufacturing, the CNC or laser cut pattern merges two parts into one single part. This lowers cost, saves materials, and reduces errors from the possible incorrect placement or alignment of two parts which are now produced as a single part.

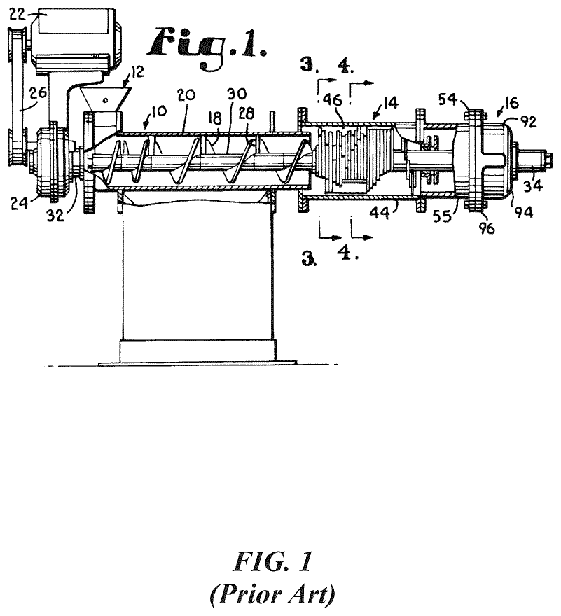

FIG. 1 illustrates a prior art reference showing a pelletizer die which includes bolted flanges that were inherently difficult to relocate properly so that the screw had proper clearances when the pelletizer die was disassembled and cleaned. The prior art had a very simplistic shaft seal that did not provide much bearing surface and could jam the pelletizer if dry material was accidentally reintroduced. This system also had a screwed in packing compression thread that had a high likelihood of freezing up when corroded sugars were present, thus making it difficult to remove without causing damage. The prior art did not include a replaceable packing gland.

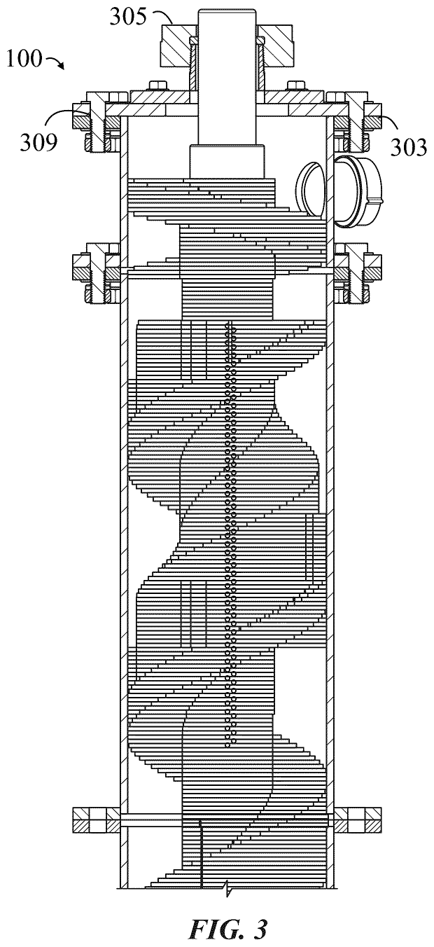

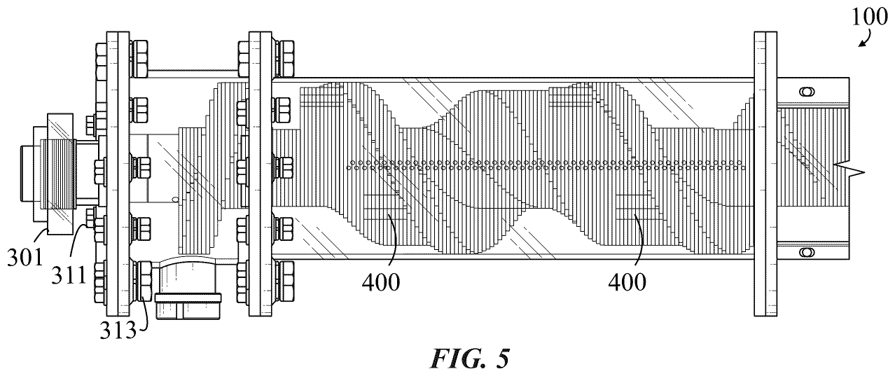

FIG. 3 and FIG. 5 illustrate the removable pelletizer die 100 which has a low pressure extruder and pelletizer which can be stopped such that the pelletizer die end seal can be easily removed to clean the pelletizer die perforations as well as the spaces of the auger plates that form the extruding rotor. The system includes a plurality of pins 309 per flange set which allows an operator to reinstall the pelletizer die 100 in the exact position it was removed from. The pelletizer die 100 includes a machined drive side shaft seal as well as a new end seal 303 with a removable internal bushing, larger surface for packing material 301, and packing cap 305 with the outside flange surface to compress the packing. Small bolts 311 and large bolts 313 retain the components of the device in a fixed position.

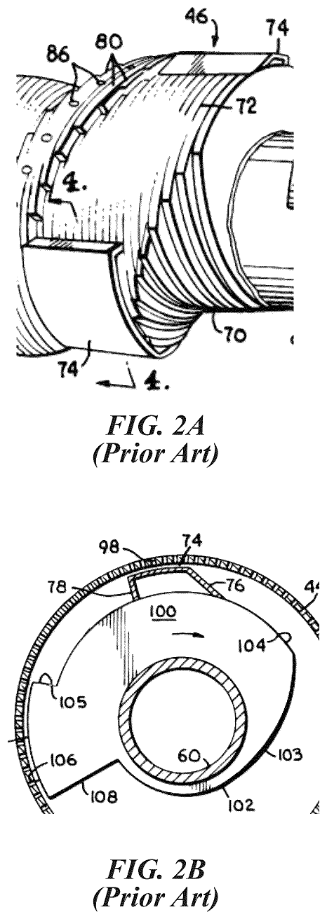

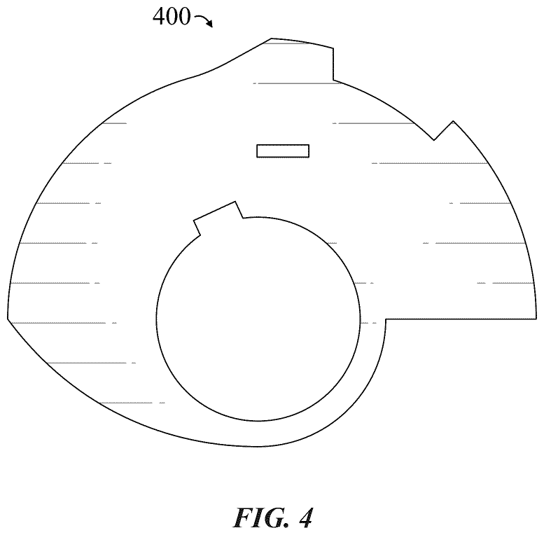

FIGS. 2A and 2B illustrates a prior art reference which includes two parts which are now manufactured as a single part (see FIG. 4) using CNC or laser cutting processes. The new process lowers labor and material costs, reduces manufacturing time, and reduces errors form the possible incorrect placement or alignment of two components which are now manufactured as a single component.

In reference to FIG. 4, the single-part pusher face plate wedge 400 is illustrated, wherein the extruder rotor plate replaces the 2-part pusher face wedge disclosed in the prior art (see FIGS. 2A-2B).

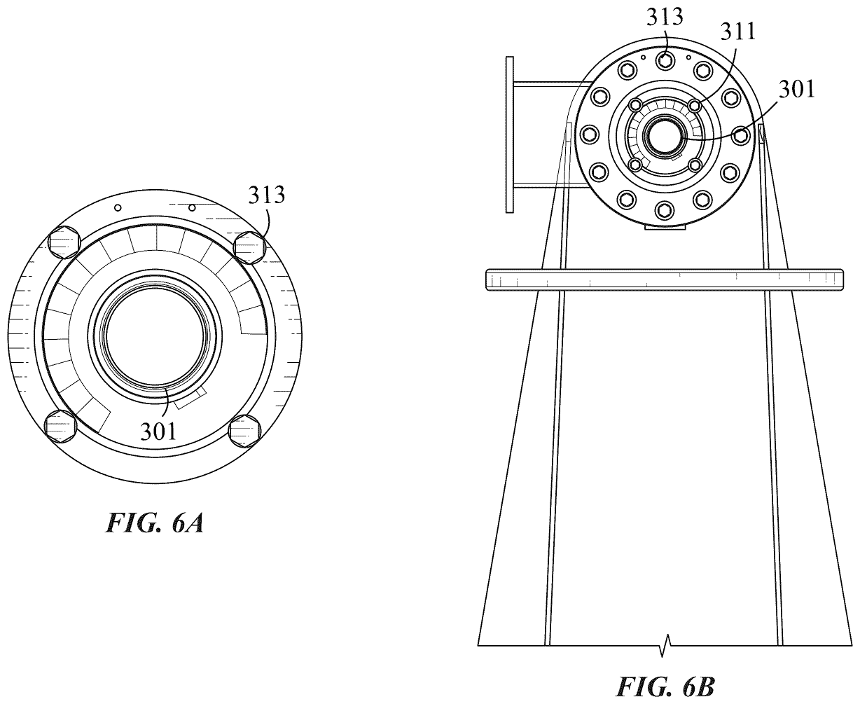

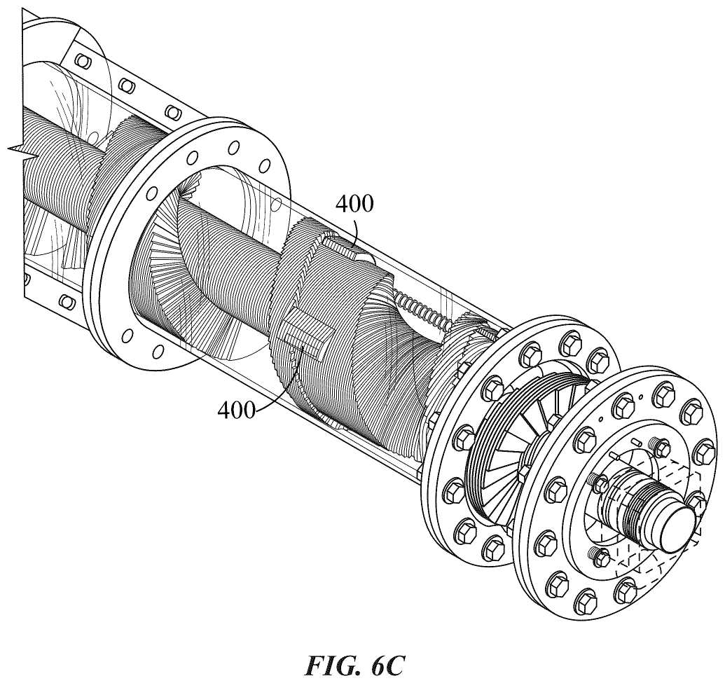

FIG. 6A, 6B, 6C illustrate the precision pins, packing material 301, surface for the packing material 301, small bolts 311 and large bolts 313.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A pelletizer with a removable pelletizer die comprising:
a plurality of bolts and a plurality of precision pins each provided in a plurality of flanges to fasten a pelletizer die, the plurality of bolts and the plurality of precision pins to enable an operator to disassemble and clean a pelletizer die and replace the pelletizer die in a suitable position;
a drive side shaft seal and an end each having a removable internal bushing, a larger surface and packing with an outside flange surface using the plurality of bolts to compress the packing.

2. The removable pelletizer die of claim 1, wherein the plurality of precision pins each operate as a locator pin to enable the operator to remove the removable pelletizer die and replace the removable pelletizer die in the same position from which it was removed.

3. The removable pelletizer die of claim 1, further comprising a plurality of perforations for forming a pellet from a dried material.

4. The pelletizer of claim 1, further comprising a plurality of auger plates arranged to form an extruding rotor.

5. The removable pelletizer die of claim 1, wherein the removable pelletizer die is further comprised of: at least one removable internal bushing.

6. A pelletizer with a removable pelletizer die, comprising:
a plurality of bolts and a plurality of precision pins each provided in a plurality of flanges to fasten a pelletizer die, the plurality of bolts and the plurality of precision pins to enable an operator to disassemble and clean a pelletizer die and replace the pelletizer die in a suitable position;
a drive side shaft seal and an end each having a removable internal bushing, a larger surface and packing with an outside flange surface using the plurality of bolts to compress the packing; and
an extruding rotor integrated with a pusher face plate wedge.

7. The pelletizer of claim 6, wherein the extruding rotor of the auger is constructed with multiple auger plates that are formed with a single-component push face wedge.

8. The removable pelletizer die of claim 6, wherein the plurality of precision pins each operate as a locator pin to enable the operator to remove the removable pelletizer die and replace the removable pelletizer in the same position from which it was removed.

9. The removable pelletizer die of claim 6, further comprising a plurality of perforations for forming a pellet from a dried material.

10. The pelletizer of claim 6, further comprising a plurality of auger plates arranged to form an extruding rotor.

11. The removable pelletizer die of claim 6, wherein the removable pelletizer die is further comprised of: at least one removable internal bushing.
